(19) United States
(12) Patent Application Publication
(10) Pub. No.: US 2004/0025422 A1
(43) Pub. Date: Feb. 12, 2004

(54) Pelletized coconut coir and method of use

(76) Inventors: Malcolm MacQuoid, Park City, UT (US); Charles Keene, Park City, UT (US)

Correspondence Address: Randall B. Bateman, P.O. BOX 1319, SALT LAKE CITY, UT, 84110-1319, US

(21) Appl. No.: 10/419,060

(22) Filed: Apr. 18, 2003

Related U.S. Application Data
(60) Provisional application No. 60/374,191, filed on Apr. 19, 2002.

(51) Int. Cl. A01G 7/00

(52) U.S. Cl. 47/9

(57) ABSTRACT

A pellet formed from coconut coir can be used for a variety of purposes including absorbing spilled liquids, as an animal litter, as a soil conditioner and as a seed carrier, growth medium. Preferably, the pellets are made from at least 50 percent by volume coconut coir and may include an additive such as a binding agent, a fertilizer, an insecticide, a weed killer, a fire enhancer, clay and seeds. The pellets allow for easier transport of the coir and for more controlled application of coconut coir to a predetermined site.

### RELATED APPLICATIONS

The present application claims the benefit of U.S. Provisional Patent Application Serial No. 60/374,191, filed Apr. 19, 2002 (which is expressly incorporated herein by reference).

### BACKGROUND OF THE INVENTION

1. Field of the Invention

The present invention relates to pelletized coconut coir and methods of producing the same. Additionally, the present invention relates to a variety of uses for pelletized coconut coir.

2. State of the Art

For decades it has been known that coconut coir is highly effective for absorbing oil and other hydrocarbons. Coconut coir is a natural by-product of growing coconuts. The husk of the coconut is formed of long fibers and small, dust-like particles. The long fibers are often used for a variety of purposes such as making rope and fabrics, etc. Coconut coir is the small, sometimes dust-like, particles which fall away when the long fibers are removed.

Recently, it has also been discovered that coconut coir has numerous other uses. For example, coconut coir has been found to be a valuable soil supplement. It can also be used to enhance vegetable gardens, to minimize the negative environmental effects of mining, and to promote reclamation of environmentally damaged sites. In each of these situations, the coconut coir both adds nutrients to the soil, and helps to retain water which can be used by plants.

Ironically, coconut coir can also be an environmental nuisance when present in vary large quantities. The presence of large mounds of coconut coir in coconut plantations promotes the breading of insects which damage coconut trees. Thus, utilizing coconut coir at other locations not only can improve the environment where it is used, it also helps coconut producers avoid infestations.

Coconut coir has also been found to be highly effective as an animal litter due to its ability to absorb up to nine times its weight in liquid while minimizing odor. Coconut coir is also highly effective at absorbing surplus or spilled paint, printers ink and a variety of uses.

While the ability of coconut coir to absorb oil and other liquids has been known, it has one significant draw back. The coconut coir is extremely fine and dust like. Even a small breeze can cause the coir to be picked up and blown about. Unless the air is extremely calm, much, if not most, of coconut coir thrown over an oil spill can be blown into area not needing the coir.

As with its use as an oil absorbent, the dust-like nature of coconut coir is a significant limitation on its use in other areas. When used as an soil supplement or for environmental reclamation, the dust-like nature limits the ability to even spread the coconut coir on the soil being treated. Typically, the coconut coir is spread on the soil being treated and then tilled into the ground. This should be done in very calm conditions, however, because even a moderate wind can quickly create a dust cloud, removing the coir from the intended area and creating potential visibility problems if the area is adjacent to a road.

The dust-like nature of coconut coir also limits the practicality of coconut coir for other uses. If the coconut coir is very fine and dry, coconut coir dust can be kicked up by horses and create dusty conditions in a barn. Likewise, a cat having coconut coir in its litter box may track small particles of coir into other areas of the house.

Likewise, if the coconut coir is fine and dry, the dust can interfere with machinery or leave fine layers of dust on work areas when used as a floor cleaner in industrial settings. Because of these difficulties, coconut coir is not widely used despite its exceptional properties as an absorbent. Thus, there is a need to provide a method and formulation of coconut coir which reduces or eliminates the disadvantages traditionally associate with coconut coir. Such a method should make the coconut coir easier to use without appreciably increasing its cost.

### SUMMARY OF THE INVENTION

It is an object of the present invention to make a more convenient form of coconut coir.

It is another object of the present invention to make such a form of coconut coir which is relatively inexpensive.

The present invention involves the formation of coconut coir into pellets. The pellets enable a predetermined amount of coconut coir to be held together during transport and initial use. The pellets prevents the coconut coir from being blown by the wind, or from being carried away by animals etc. It does not, however, materially interfere with the ability of the coconut coir to perform as an absorbent in a variety of applications.

Preferably, the coconut coir pellets are between ⅛ and M inch in diameter and between about ¼ and 1 inch long. The specific desired size depends on the use of the coir. These sizes allow the coconut coir to be easily transported and dispensed, while allowing the coconut coir to still be used for its intended purpose. Those skilled in the art will appreciate that different sizes may be ideal for other applications.

In accordance with one aspect of the present invention, the pellets are formed by compressing coconut coir. This can be done in a conventional pellet mill. The resulting coconut coir pellet is reduced in size by about 30 to 60 percent over the same amount of coconut coir in an uncompressed form. This makes the coir easier to transport than uncompressed coir. (While coir is commonly shipped in compressed bails, using the coir requires breaking the bales and can create considerable dust.)

Coconut coir can have considerably difference in the moisture content depending how long the coconut coir has been sitting and the environmental conditions. For example, fresh coconut coir can have a moisture content of about 45 percent by weight. If the coir has been sitting for an extended period of time in a dry climate, the moisture content can be below 10 percent. If the coconut coir is to dry, it may have difficulty sticking together in the pellet. Thus, steam may be added.

The different intended use of the coconut coir, however, may dictate different moisture contents to maximize results. Thus, if the coconut coir is to be used as a soil conditioner, it may be desirable to produce the coconut coir pellets with a higher content. If, in contrast, the pellets are intended to be used as an absorbent, a lower moisture content is desirable (preferably below 30 percent, more preferably below 20 percent and most preferably below 10 percent). This can be achieved by drying the pellets to reduce moisture content. The pellets can be dried by air drying, in an oven or by freeze drying.

While the pellets hold together fairly well during transport and application a small amount of coir dust, called fines, will break loose from the pellet. The quantity of fines can be increased by cutting the pellets or partially grinding them. When liquid is added to the coconut coir pellets, the fines will quickly mix with the liquid. The pellets will then begin absorbing moisture, causing the coir to swell. Unless the pellets are manually broken apart, however, the coir will still tend to clump together, thereby reducing dust and facilitating clean-up.

In accordance with another aspect of the invention, the coconut coir pellet is formed with a fertilizer additive. The fertilizer is disposed so that it will be released into the soil to which the coconut coir is added. Thus, buy adding coconut coir pellets to the soil, the soil can be enhanced with improved moisture and aeration capacity, while simultaneously adding additional nutrients.

The fertilizer added to the coconut coir can either by a chemical fertilizer, such as nitrogen mixtures commonly applied to lawns, or natural fertilizes such as turkey manure, chicken manure or steer manure. Obviously, the type of manure and the intended use may impact the ratio of fertilizer and coconut coir. Thus, the fertilizer may be anywhere from about 50 percent to as lower of 2-5 percent of the pellet.

In accordance with another aspect of the present invention, a fire enhancer is added to the coconut coir in the pellets to facilitate burning of the coconut coir after it has been used to absorb a fluid. Such a pellet would typically be used when the pellets are used to clean oil or other hydrocarbons from a surface, or as a retaining medium for used motor oil. Once collected, the oil impregnated coir can be incinerated, thereby eliminating the environmental problem of oil disposal, while providing a fuel source which can be used to heat buildings. Pellets containing a fire enhancer can also be used as a fuel source for a pellet burning stove.

In accordance with yet another aspect of the present invention, an additive in the form of an odor controlling compound may be added. Materials such as conventional deodorants, gypsum and zeolite are known as odor controllers. One form of zeolite sold under the mark ZIX by ZIX, Inc. of Memphis, Tenn. is commonly sold in agriculture supply stores for controlling odors associated with livestock and the like. By forming a pellet having coconut coir and zeolite, etc., a highly absorbent, highly odor controlling compound may be formed.

Another additive which can be used to control odor is fruit and fruit by-products. Citrus peels are known for helping to mask or absorb odors. Additionally, some fruit byproducts left over from making fruit juice, etc., are highly absorbent. Furthermore, pieces of fruit could be added to the coconut coir prior to pelletizing to provide a pleasing aroma to the pellets.

In accordance with still another aspect of the present invention, the coconut coir pellet can include conventional clay-based absorbents. For example, kitty litter can be formed by a pellet containing coconut coir and a small amount of conventional litter. The coconut coir dramatically reduces the amount of clay-based absorbent used. This not only reduces the amount of silica dust associated with kitty litter, it also reduces the negative environmental impacts associated with mining the clay used in kitty litter.

In accordance with yet another aspect of the present invention, a binding agent can be added to the coconut coir so minimize the tendency of the coconut coir to separate as the particles swell with a liquid being absorbed, thereby maintaining the coconut coir in pellet form.

In accordance with still another aspect of the present invention, seeds are added to the coconut coir pellets. The coconut coir pellets can then be mixed with soil to serve as a growth medium for the seeds. In the alternative, the seed laden pellets can be applied to the top of soil. Thus, the seed laden coconut coir pellets can be used to plant flower gardens or lawns simply by spreading the pellets on the soil. Additionally, the seed laden coconut coir can be used in efforts to replant areas burned by fires, etc. Because of the coconut coir's ability to absorb and hold water, the coir can increase the ability of rapidly producing plants to minimize erosion, etc.

### BRIEF DESCRIPTION OF THE DRAWINGS

The above and other objects, features and advantages of the invention will become apparent from a consideration of the following detailed description presented in connection with the accompanying drawings in which:

FIG. 1A shows a perspective view of a coconut coir pellet made in accordance with the principles of the present invention;

FIG. 1B shows a perspective view of an alternate embodiment of a coconut coir pellet made in accordance with the principles of the present invention;

FIG. 2 shows a perspective view of a pellet formed from coconut coir and an additive;

FIG. 3 shows a perspective view of a pellet formed from coconut coir and seeds; and

FIG. 4 shows a perspective view of a prior art pelletizing system which can be used to form coconut coir pellets and pellets formed from coconut coir and a variety of other additives.

### DETAILED DESCRIPTION

Reference will now be made to the drawings in which the various elements of the present invention will be given numeral designations and in which the invention will be discussed so as to enable one skilled in the art to make and use the invention. It is to be understood that the following description is only exemplary of the principles of the present invention, and should not be viewed as narrowing the pending claims.

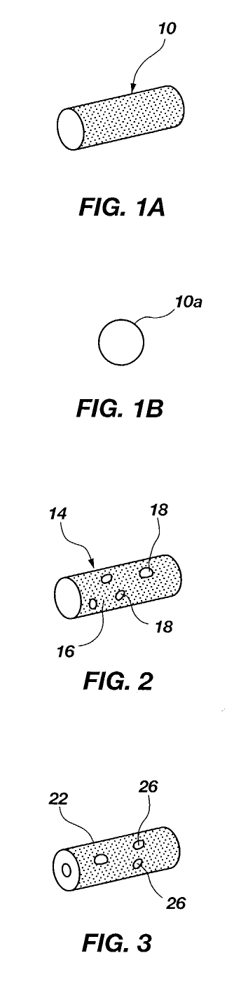

Turning now to FIG. 1A, there is shown a pellet, generally indicated at 10, made in accordance with the principles of the present invention. The coconut coir pellet 10 is typically made by passing the coconut coir through a pellet mill. If the coconut coir is very dry, steam can be added to provide sufficient moisture that the coconut coir particles tend to bind to one another and stay generally stable in the pellet. The pellets can then be dried by air drying, heating in an oven, or by freeze drying.

By compressing the coconut coir into a pellet, the volume consumed by the coconut coir is decreased by approximately 30-60 percent. This allows the coconut coir to be handled and shipped more easily. A bag holding a given volume of coconut coir can be up to about 60 percent less in volume than a container containing non-compressed coconut coir.

To handle coconut coir, it is presently the common practice to form large bales of compressed coir. The bales can reduce the volume needed for storing and shipping the coir by more than ⅓. Once the bales are cut open, however, coconut coir tends to spill everywhere. In contrast, the pellets 10 provide a more controllable unit of the coconut coir and it is easier to sweep up in the event of a spill.

In use, the coconut coir pellets 10 allow the user to take a handful or bucket full of the coir and throw it on a site. The site may be a spill of some fluid, a litter box or a portion of a garden. Unlike regular coconut coir which can create a cloud of dust and drift with any breezes, the coconut coir pellets fall quickly to the ground and begin performing the use.

As the pellets 10 are exposed to liquid, the coir particles begin to swell and the pellet will begin breaking apart. However, the coir particles still tend to clump together, thereby reducing coir dust from being carried away by wind or animals. If the coir pellets 10 are being used to absorbed liquid, the coir can be scooped up once the liquid is absorbed. If the coir pellets 10 are being used as a soil conditioner, etc., they can be left in the soil where they will gradually fragment into smaller pieces of coir. Because of the pellet form, however, the coir is provided with much more time to be worked into the soil than coir dust allows.

While a presently preferred embodiment of the coconut coir pellet 10 is the elongate, substantially cylindrical configuration shown in FIG. 1A, the pellets 10 can be formed in a variety of different configurations. Thus, FIG. 1B shows a substantially spherical pellet 10a made of coconut coir.

Turning now to FIG. 2, there is shown an alternate embodiment of a coconut coir pellet, generally indicated at 14, made in accordance with the principles of the present invention. The pellet 14 is similar to the coconut coir pellet 10 shown in FIG. 1A. The difference is that the pellet 14 is formed from a combination of coconut coir 16 and at least one additive 18.

What additive 18 is integrated into the pellet 14 will often depend on the desired use of the pellet. For example, if the pellet 14 is to be used as a soil conditioner, the additive 18 may be a fertilizer or other soil nutrient. Additionally, the fertilizer may be chemical, or may be a natural fertilizer such as turkey, chicken or steer manure. The additive could also be an insecticide, or a weed killer, micro-organisms which may be beneficial to plants, or a combination of these additives. As the coconut coir is mixed into the soil it will allow the additive to be gradually released, thereby improving soil condition in a variety of ways.

In the formation process of the pellet 14, the additive 18 can be mixed with the coconut coir. The coconut coir should ideally be at least 40 percent of the total volume of the pellet, and is preferably between about 50 and 95 percent of the volume depending on the desired use of the pellet. The coconut coir is mixed with the additive and subjected pressure to form a pellet of the desired size and shape. If needed, steam or some other water source can be used to ensure good formation of the pellets. The coir and additive pellet can then be dried if desired.

The additives 18 in the pellet 14 can also be numerous other compounds depending on the desired use of the pellet. For example, when the coconut coir is to be used to clean up oil spills and then burned for fuel, the additive 18 can be any of a number of compounds, such as kerosene, other hydrocarbons or vegetable based flammable material, which will promote burning. (Depending on the type of hydrocarbon absorbed, no fire enhancement may be needed). The pellets can then be burned commercially for fuel. In the alternative, the pellets can be used in a wood pellet stove as a fuel source.

In other contexts where it is very important to minimize coir dust, the additive 18 can be a binding agent or adhesive, such as corn starch or other binders commonly used for pelletizing feed, etc., which tend to hold the coir particles together. Thus, for example, kitty litter can be formed which is both highly absorbent and which reduces the risk of spreading coconut coir dust to other locations of the house. Those familiar with many clay-based brands of kitty litter will appreciate that the silica dust can become a considerable nuisance. Not only can it be tracked all over one's house, many believe that the silica dust raises health concerns for the cats. In contrast, coconut coir has no known negative effects for animals, and is a more desirable absorbent for use as a kitty litter.

If the pellets 14 are being used as a litter/stall material, the additive 18 can also include clay-based absorbents if desired. However, due to the silica dust, it is more likely that the additive(s) 18 can include zeolite, deodorants or other odor controlling/masking compounds. While coconut coir is good at minimizing urine odors, the addition of a small amount of zeolite can further reduce the smell associated with animal urine. Likewise, a small amount of citrus peel can absorb odors. Furthermore, some by-products of making fruit juices are highly absorbent portions of the fruit which can also assist with containing liquid.

In addition, the additive may be a coloring agent. Thus, for example, if the coconut coir pellets are being used to clean up an oil spill on a body of water, a coloring agent can be included as part of the pellet to make the coconut coir more visible and easy to remove from the water once it has had time to absorb some of the oil.

The coconut coir pellets are highly effective at controlling liquid. With both oil and water based liquids, tests have shown that the coir dust which breaks off the pellets quickly begins absorbing the liquid. Absorption is continued by the pellets. While the coconut pellets swell, they still tend to clump together, thereby isolating the liquid and making clean-up more practical.

While the additive 18 may be chemical or organ byproducts, other things may also be added to the coconut coir pellets. Thus, FIG. 3 shows a pellet 22 which is formed from coconut coir 24 and seeds 26. (Fertilizer can also be included if desired.)

The pellet 22 can be spread on top of soil being planted or can be mixed into the soil. As the coconut coir 24 gets wet, it will tend to swell and release the seeds 26. The moisture in the coconut coir 24 keeps the seeds 26 moist while the germinate, thereby improving the likelihood of survival of the seed.

The use of pellets 22 which contain coconut coir 24 and seeds 26 is particularly advantageous where a large area of ground must be seeded. Furthermore, it is particularly advantageous where the availability of water is not consistent. Thus, for example, if a fire has burned of grasses in a remote location, it is often necessary to reseed the land to prevent long-term soil erosion. In arid parts of the world, however, it can be difficult to ensure that the seeds have sufficient moisture to germinate and grow. The coconut coir pellets 22 containing seeds 26 allow the seeds to be released and germinate while the coir keeps moisture readily available. Thus, the likelihood that the seeds will grow and provide root growth that will minimize erosion is enhanced. Furthermore, by forming the pellets from coir having a relatively high moisture content, i.e. about 45 percent, the weight of the pellets is increased and the pellets can be air-dropped onto an area that needs reseeding. This is particularly advantageous in remote portions of the American west.

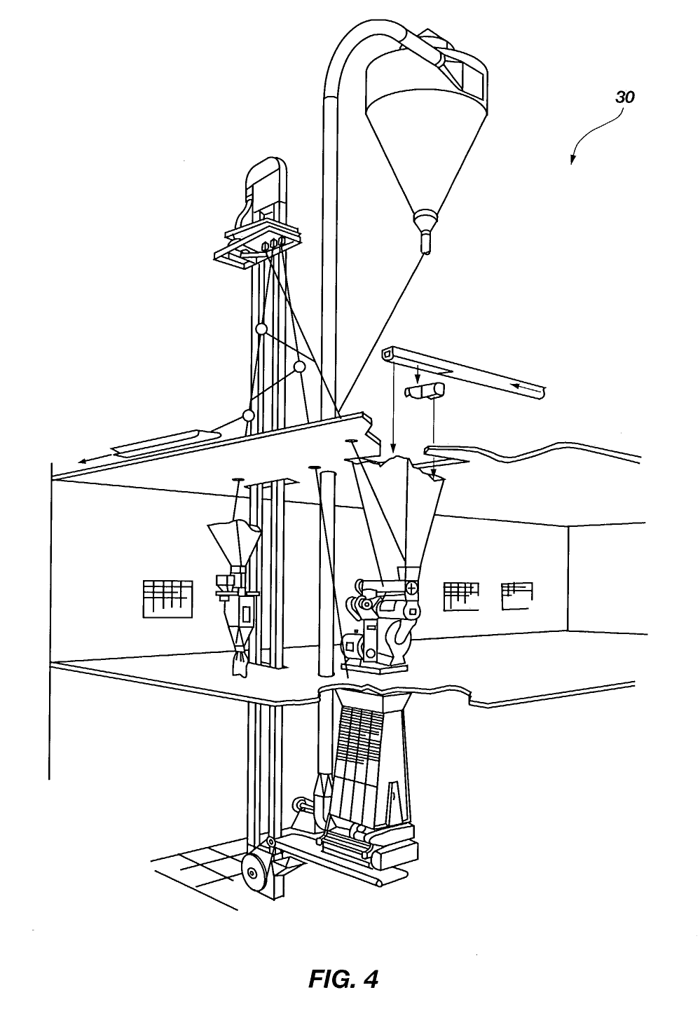

Turning now to FIG. 4, there is shown a pelletizing system flow diagram of a system which is commonly used to create commercial feed pellets. The system 30, is made by California Pellet Mill and will not be discussed in detail, as those skilled in the art can readily obtain literature regarding the pelletizing process using such machines. The system 30 allows grains, cereals and combinations thereof to be formed into pellets for feeding livestock. In light of the present disclosure, those skilled in the art of pelletizing feed and the like will be able to form coconut coir pellets, or pellets containing coconut coir and one or more additives. The system can also include crumblers to provide a predetermined amount of coir dust, if desired.

Thus, there is disclosed an pellet, and method for making and using the same which includes coconut coir. Those skilled in the art will appreciate numerous modifications to the present invention which can be made. For example, the additives can be mixed with the coconut coir prior to formation as a pellet, or can be coated on the outside of the pellet. The appended claims are intended to cover such modifications.

What is claimed is:

1. A pellet comprising at least 40 percent by volume coconut coir.

2. The pellet according to claim 1, wherein the pellet is formed exclusively from coconut coir.

3. The pellet according to claim 1, wherein the pellet is between 50 and 95 percent by volume coconut coir.

4. The pellet according to claim 1, further comprising an additive.

5. The pellet according to claim 4, wherein the additive comprises fertilizer.

6. The pellet according to claim 5, wherein the additive comprises a chemical fertilizer.

7. The pellet according to claim 5, wherein the additive comprises at least one of the group consisting of turkey manure, chicken manure and steer manure.

8. The pellet according to claim 4, wherein the additive comprises insecticide.

9. The pellet according to claim 4, wherein the additive c comprises weed killer.

10. The pellet according to claim 4, wherein the additive comprises micro-organisms

11. The pellet according to claim 4, wherein the additive is a fire enhancing agent.

12. The pellet according to claim 4, wherein the additive is an odor controlling agent.

13. The pellet according to claim 12, wherein the additive comprises zeolite.

14. The pellet according to claim 12, wherein the additive comprises a fruit by-product.

15. The pellet according to claim 4, wherein the additive is clay.

16. The pellet according to claim 4, wherein the additive is a binding agent.

17. The pellet according to claim 4, wherein the additive is a coloring agent.

18. The pellet according to claim 1, wherein the pellet further comprises at least one seed.

19. The pellet according to claim 18, wherein the pellet further comprises fertilizer.

20. The pellet according to claim 18, wherein the pellet is formed by a plurality of seeds mixed in coconut coir.

21. A method of forming kitty litter, the method comprising compressing coconut coir to form a plurality of pellets and using the coconut coir pellets as kitty litter.

22. The method according to claim 21, wherein the method comprises forming the pellets from a mixture of coconut coir and at least one additive, wherein the coconut coir is at least 50 percent by volume of the pellet.

23. The method according to claim 22, wherein the method comprises forming the pellets from coconut coir and at least one of the group consisting of an odor controlling agent, a fruit by-product and a binding agent and clay.

24. A method for conditioning soil, the method comprising forming coconut coir into a pellet and distributing the pellets on the soil.

25. The method according to claim 24, wherein the method further comprises forming the pellets from coconut coir and at least one additive, the coconut coir being at least 50 percent of the pellet by volume.

26. The method according to claim 25, wherein the additive comprises at least one of the group consisting of fertilizer, insecticide, binding agent, clay and weed killer.

27. A method for planting soil, the method comprises disposing on the soil a plurality of pellets comprising coconut coir and seeds.

28. A method for transporting coconut coir, the method comprising forming the coconut coir into pellets and disposing the pellets in a container.

29. A method for cleaning up a spilled liquid, the method comprising dispensing pellets made from at least 50 percent coconut coir on the liquid so that the liquid is absorbed by the coconut coir.

30. A method for forming coconut coir pellets, the method comprising selecting a quantity of coconut coir dust and subjecting the coconut coir dust to pressure to form pellets.

31. The method according to claim 30, further comprising drying the pellets.

32. The method according to claim 31, wherein the method comprises heating the pellets in an oven.

33. A pellet comprising coconut coir, wherein the coconut coir pellet has less than 30 percent moisture by weight.

34. The pellet according to claim 33, wherein the pellet has less than 20 percent moisture by weight.

35. The pellet according to claim 34, wherein the pellet has less than 10 percent moisture by weight.
